(19) United States
(12) Patent Application Publication
(10) Pub. No.: US 2018/0282048 A1
(43) Pub. Date: Oct. 4, 2018

(54) Sachet System

(71) Applicant: Medimark Scientific Limited, Seal, Kent (GB)

(72) Inventors: Paul Roy Hayman, Seal, Kent (GB); Richard James Hayman, Seal, Kent (GB); David Robert Norton, Wimborne, Dorset (GB)

(21) Appl. No.: 15/763,759

(22) PCT Filed: Sep. 23, 2016
(86) PCT No.: PCT/GB2016/052968

§ 371 Date: Mar. 27, 2018

(30) Foreign Application Priority Data
Sep. 28, 2015 (GB) 1517108.5

(51) Int. Cl. B65D 81/32; A01N 25/34; A01N 59/00; C09J 133/12; C11D 3/39

(52) U.S. Cl. CPC B65D 81/3272; A01N 25/34; C11D 3/3945; C09J 133/12; A01N 59/00

(57) ABSTRACT

A sachet system enclosed in a pouch is described, the pouch comprising at least two strips of film material of approximately the same size, one overlaid on the other, sealed together at their edges and further sealed together at least once at a point along at least one axis with a partial seal to form at least two joined substantially planar regions, one of which regions comprises a first compartment, another of which regions comprises a second compartment, and wherein the first compartment is separated from the second compartment by the partial seal. This sachet is described as comprising a burstable portion containing a fluid and located in the first compartment, the partial seal providing a communication path between the first compartment and the second compartment, and wherein the system is capable of being manipulated such that the burstable portion bursts, and arranged such that a fluid contents spilling from the burstable portion is communicated from the first compartment to the second compartment. A wetable material may be provided in the second compartment, whereby the wetable portion is wetted by a said fluid contents. A manufacturing method is also described.

The invention relates to a sachet system for creating and applying a dual liquid formulation to, for example, a wiping material whilst in a controlled environment. The invention also relates to a manufacturing process for same.

There exists a need to treat fabric and material with a cleaning or antibacterial agent prior to using the material for cleaning or swabbing purposes. There a number of current techniques for doing this and a range of equipment for assisting with the task. A wetable material, such as a wet wipe, can be kept in a moist state in a sealed environment soaked with the agent required. The efficacy of the agent will often reduce with the length of time it is stored and has been applied to the wipe and so this technique is not reliable for products with a short shelf life or half life. The wipe can instead be stored in a dry state and only wetted with the agent when it is required for use, however the thoroughness of the application, particularly if human manual application is used, is doubtful.

The difficulties of maintaining an activated solution and application are further complicated if the activated biocidal condition is to be achieved on site with the application of one of more reagents onto the wipe. An example of this would be where a wetable material had been pre loaded with an amount of a first reagent which is then subjected to a manual application of a second reagent to achieve an activated state. The application and any measuring of solution would be open to human error, which could lead to an ineffective wipe material. Despite the issues with application this subsequent application of a second reagent or substance to an already wet material or wipe is still used, in the absence of another solution.

The present invention seeks to improve the existing techniques and packages for application of a biocide.

According to an aspect of the present invention there is provided sachet system enclosed in a pouch, the pouch comprising at least two strips of film material of approximately the same size, one overlaid on the other, sealed together at their edges and further sealed together at least once at a point along at least one axis with a partial seal to form at least two joined substantially planar regions, one of which regions comprises a first compartment, another of which regions comprises a second compartment, and wherein the first compartment is separated from the second compartment by the partial seal, the sachet system comprising a burstable portion containing a fluid and located in the first compartment, the partial seal providing a communication path between the first compartment and the second compartment, and wherein the system is capable of being manipulated such that the burstable portion bursts, and arranged such that a fluid contents spilling from the burstable portion is communicated from the first compartment to the second compartment.

This provides for the creation of a controlled amount and controlled concentration of a biocide, and in turn its application to material for wiping.

It has been noted that there exists a need to create highly effective cleaning or antibacterial agents which have limited shelf life by mixing an active solution and an activator solution in-situ at the time of use, after which the active chemistry can be diluted with water for cleaning or swabbing purposes. In some cases the efficacy of the active agent reduces with the length of time it is stored. The invention means that the active agent can be created in-situ when required from two stable chemistries each stored in secure, inert packaging in a dry contamination free state where the precise dose and concentrate of each chemistry can be controlled to guarantee an active chemistry with exactly the desired concentration and volume.

This sachet system means that the whole package can stay clean and, if required, sterile, before activation and use. The fluid stored in the burstable portion can be pre measured and sealed to maintain its useage and functionality. The fabrication of the sachet system can be by standard manufacture and storage and sealing techniques.

In an embodiment the burstable portion comprises a sachet comprising at least two strips of film material of approximately the same size, one overlaid on the other, sealed together at their edges, wherein the seal at one edge is weaker than the seal at the other edges, whereby under manipulation the weaker seal is caused to fail so as to burst the sachet and spill the contents of the sachet.

The general need to create an active solution with the correct concentration and volume for subsequent use as a concentrate or for dilution with water is therefore addressed. In the case where the active and activating solution are highly reactive substances that need to be stored in inert containers for a long period, prior to mixing to create the activated solution, then one or more sachets are used.

In an embodiment the first compartment comprises two or more burstable sachets, and the embodiment the second compartment is wetted with an active formulation from the first compartment produced by combining the contents of the burstable sachets by simultaneous discharge of the active formulation into the second compartment. The sachets containing the solutions would be burst in the first compartment

This provides the huge advantage of being able to burst two sachets together, simultaneously. After bursting, the solutions are mixed, are activated and the active solution, which has been placed directly into the second compartment to be wetted at the point of use, could then be dispensed by opening the outer sachet. All while maintaining the sachet system in a known, clean and if required, sterile environment prior to releasing the active agent for use, for example onto a wipe material. Contamination is avoided.

If the second compartment is empty, as described, then the two chemicals can be mixed in order to create an active biocide to be used, say, from the pouch as a concentrate to be diluted in water, as opposed a biocide that would soak a wipe.

In the sachet system of the embodiment the fluid contents comprise, in particular, an active biocide produced by combining two separate liquids, wherein a first burstable sachet contains an activator and a second burstable sachet contains a base. The components are kept separate until the combination step.

Inadequate or incomplete activation of the biocidal solution can be avoided by careful measurement and loading of the burstable sachets with correct amounts of the appropriate reagents.

In an embodiment, the base is one chosen from the range; Poly(methyl) methacrylate resin, calcium hypochlorite, tetraacetylethylenediamine. Or is any similar chemical that activates another chemical in order to create a biocide, adhesive, detergent, enzyme, chemi-luminescent or similar such chemical. Also, the activator is one chosen from the range; benzoyl peroxide, adeptic acid, alkaline hydrogen peroxide. Or is any similar chemical that is activated by another chemical in order to create a biocide, adhesive, detergent, enzyme, chemi-luminescent or similar such chemical.

The embodiment comprises a base and an activator chosen for their ability to have one or more of the following example effects, from two stable solutions stored in a non-reacting state, only reacting when mixed;
a) ‘Activate adhesives’ by hardening resins with an activator, eg. when benzoyl peroxide, an activator, is mixed with Poly(methyl) methacrylate resin, an exothermic free radical polymerization occurs that ‘sets’ the resin, thereby making the mix of the two substances a powerful adhesive.
b) ‘Create biocides in-situ’, where the short-shelf life biocide created at the point of use (eg Hypochloric Acid created in-situ from Calcium Hypochlorite and Adeptic Acid)
c) ‘Create detergents’, where the reaction of tetraacetylethylenediamine (TAED) in the presence of an alkaline hydrogen peroxide solution generates peracetic acid
d) ‘Generate exothermic or endothermic reactions’, where heat can be added to, or removed from, a system by a chemical reaction that occurs when two otherwise stable substances are mixed. rg quickline and water (exothermic), Ammonium nitrate and water (endothermic),
e) ‘Create chemiluminescence’, where light is generated when two solutions are mixed, eg: luminol and hydrogen peroxide
f) ‘Bioactivate’, eg when enzymes or other biologically active molecules acquire the ability to perform their biological function, such as inactive proenzymes being converted into active enzymes

In the illustrated embodiment below, for accuracy and complete activation of the formulation a, or each, burstable sachet contains a predetermined volume of fluid.

In the illustrated embodiment the following features and materials are present to provide a simple and easy to use pouch and sachet system. In the sachet system of the present embodiment the pouch film comprises a plastics material and is transparent, this is useful to see the progress of the mixing process. In an embodiment the burstable portion comprises metal foil sachets, in particular silver foil sachets, this material has good long life, stable storage properties. The pouch film seals and sachet film seals are sealed by heat sealing. This is a conventional and known technique. In one version of the invention operation the manipulation of the pouch is carried out manually. In another, the manipulation of the pouch is carried out in an automated manner. In an embodiment the pouch and component portions are maintained in a sterile, clean state.

In addition to the above described embodiments there exists a need to apply a controlled volume of active and activator chemistry onto a wipe to create a wet wipe dosed with the correct concentration and volume of activated solution. In an embodiment the second compartment of the sachet system comprises a wetable material portion, and whereby the wetable portion is wetted by a said fluid contents. The wetable portion of the embodiment is one chosen from the group; wetable fabric material, paper, tissue, gauze, wet wipe material. In an embodiment the portion to be wetted may be initially dry. This means the exact measure of fluid to effect thorough wetting of the material can be known and calculated based on the starting point of an entirely dry material or fabric. For use of the wetable material, in an embodiment a perforated or weakened area of the pouch is arranged for ease of opening such that the contents of the sachet may be released, or the wetable material portion may be removed from the pouch for use.

There are existing devices for hand pumping and spraying a liquid drawn in from a container out through a nozzle. A single liquid stored in a single container is accommodated and one or more of this type of dispenser can be used to wet the material to be wetted. In existing arrangements the different fluids stored in different containers can be alternated. The activation of the biocide onto the material to be wetted would occur after both reagents (perhaps from two different dispensing bottles) reached the material to be wetted, mixed and were activated. A similar stage of activation exists in the case where a material or wipe is pre soaked in one reagent and the second reagent is then applied manually, by spray or wetting. The application and achievement of biocidal condition in both cases is not secure and is not in a clinically clean environment. The risk of incomplete activation of the reagents to form a biocide is high and it is uncertain if the wetted material is properly biociodal. This method is most insecure because the manual application of the second reagent is uncertain as to exact volume dispensed. Consequently, there is always uncertainty as to whether the finally prepared wipe is properly biocidal under all regulated microbiocidal conditions that may be claimed for it.

In contrast the master envelope or pouch of the present invention can if necessary maintain the envelope in sterile conditions and the burstable sachets provide accurate mixing of two known (measured, predetermined) reagents, The sachets are burst together and combine in the compartment to form an activated solution. The solution in the embodiment is an activated solution such as a sporicide and with the action of transferring the activated solution from the compartment containing the burstable sachets to the compartment with the wetable material the activation is completed and the solution is ready to use. The solution can be directly placed on to the material to be wetted which is ready to receive it in the other compartment. The pouch is sealed, no activated solution is lost. In other words the pouch encloses all three components of the system (two reagents and a wipe). The mixing process is thus conducted in a completely controlled and if necessary sterile environment. In the previous systems the wipe receives the second reagent in open room conditions and is thus not properly hygienic in preparation.

There are further advantages to having two discrete burstable sachets as well. It has been suggested that there is a greater level of biocidal security in having the two discreet chambers, one for each fluid (activator and base) simultaneously discharging into the wipe chamber. The pre loaded, pre measured sachets already sealed in the master pouch or envelope avoid any uncertainty of being able to measure the amount of fluid that may have been pre-loaded into the wipe and hence the related efficacy of the end product. Only a precisely metered volume of fluid from each reagent can guarantee the exact mix required to achieve the full range of and exact value of, in this case, microbiocidal results and in other cases the correct level of adhesion, luminescence, cleaning, enzymatic action, or heat added to or taken away from a syatem.

In the described embodiment seapage between sachets is addressed and it maintains the efficacy of the system under stress. This is important as the sachet system products are routinely shipped worldwide through turbulent sea conditions and uneven road and trailer transport conditions. They may even be stored and used in battlefield applications. There is a risk of solution seapage between discreet chambers of existing ‘twin sachet’ schemes, when these are made from plastic. The plastic can be prone to degradation due to the high reactivity of the chemicals contained therein, and has been responsible for their diminished popularity and use. The seapage issue applies to pouches and sachets including a wetable material and to those without.

Immediately even if a minute amount of seapage occurs, the integrity of all packaging, and the biocidal efficacy of the complete mixed solution and wipe is compromised and the item must be rejected for medical or related use under the strict conditions of use that exist in all regulated medical fields. In the current invention, the sachets containing the two fluids are both composed of metal foil and are themselves contained in a third enveloping sachet. Even if seapage could ever occur, it is contained, therefore and the likelihood of compromising biocidal efficacy, or of contaminating a storage container is minimised.

According to a further aspect of the present invention there is provided a method of manufacture of a sachet system, pouch and at least one burstable portion as previously described comprising the steps of; (i) folding and sealing the burstable sachets, (ii) filling the burstable sachets with components capable of creating an active biocide when mixed and combined; (iii) folding and sealing the master pouch around the burstable sachets.

In an embodiment with a wetable material component the method of manufacture of a sachet system, pouch and at least one burstable portion further comprises the steps of; (iv) folding and sealing a wetable portion with material to be wetted and (v) folding and sealing the master pouch around the burstable sachets and the wetable portion.

According to another further aspect of the present invention there is provided a device for manufacturing a sachet system as previously described.

Embodiments of the invention will now be described in detail, by way of example only, with reference to the accompanying drawings, in which:

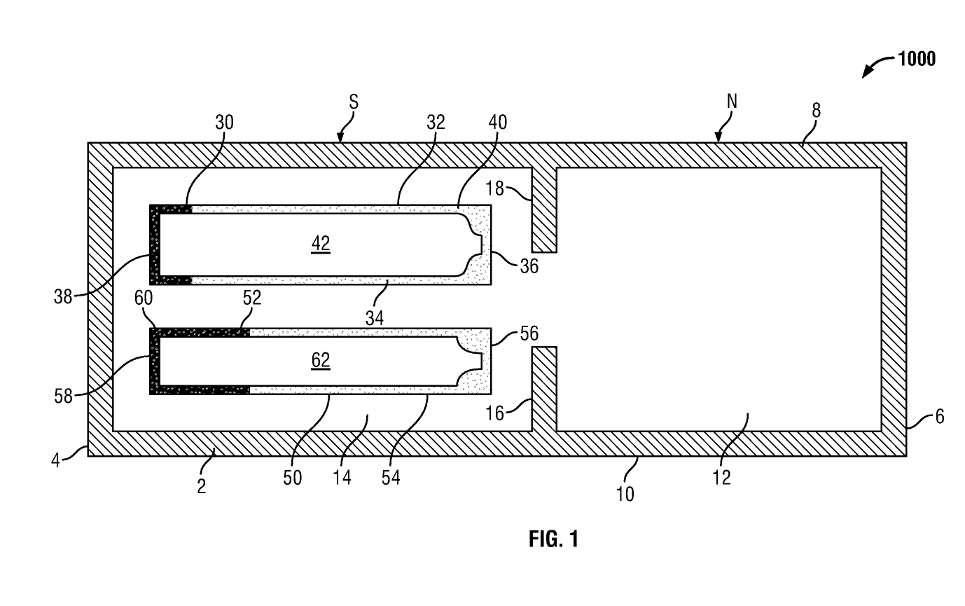

FIG. 1 is a plan view of the sachet system and components in place inside the master pouch according to an embodiment of the invention;

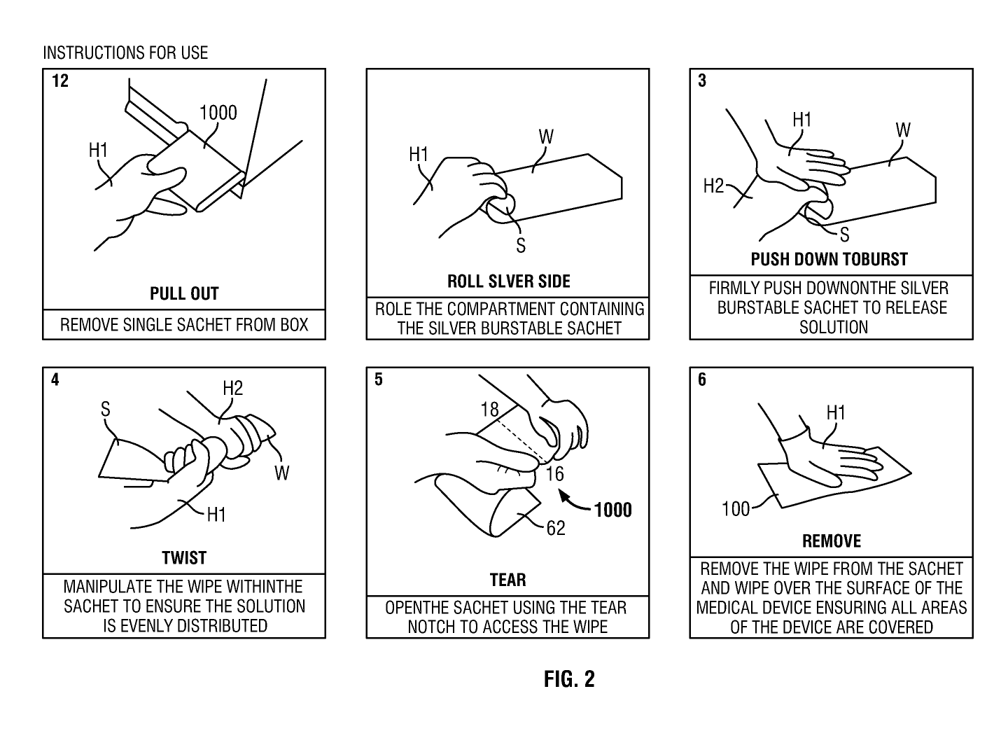

FIG. 2 is a series of instruction images for use of the sachet system of FIG. 1, including a folded conformation and the folding and manipulation of the sachet system; and

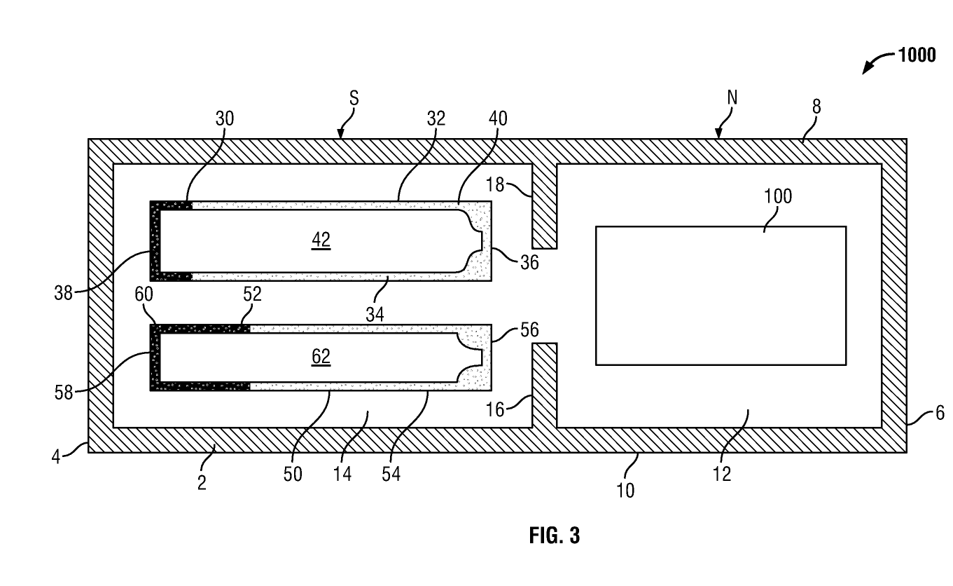

FIG. 3 is a plan view of the sachet system and components in place inside the master pouch according to a further embodiment of the invention.

FIG. 1 shows the sachet system including the burstable sachets and with an empty second compartment for receiving the contents of the burstable sachet portions. FIG. 2 illustrates how the sachet system operates in use. FIG. 3 is similar to FIG. 1 but includes a wetable material, the wet wipe, in the second compartment, in a dry state ahead of being wetted.

The planar construction of the sachet system can be seen in FIG. 1 as annotated.

The pouch 1000 is generally rectangular in shape. It comprises at least two strips of film material of approximately the same size, bounded by edges 2, 4, 6 and 8. One rectangular strip overlaid on the other, along the longitudinal axis. The edges 2, 4, 6 and 8 are sealed together forming a border 10. There is a further seal arranged so as to further seal together the pouch 1000 and to form two joined substantially planar regions S, N, The partial seal 16 is located and orientated substantially perpendicular to the longitudinal axis. The region N in a first embodiment is a void and without contents, thus this first compartment 12 is empty. The region S comprises a second compartment 14. The first compartment 12 is separated from the second compartment 14 by the partial seal 16. At least one burstable portion 30 is contained within the compartment 14 in sachet region S. In the illustrated embodiment there are two burstable portions 30, 50. The portions 30, 50 contain fluid that is activated when the fluids contact each other. The portions are of a similar construction to the pouch 1000—they have edges. 32, 34, 36, 38 and 52, 54, 56. 58 and are sealed at all edges with a seal 40, 60. The seal 40, 60 has a weaker area of sealing, often with a narrower part of a border, as illustrated. This means that the system 1000 is capable of being manipulated such that the burstable portions 30, 50 burst. The region of the partial seal 16 that remains unsealed provides a communication path between the first compartment 12 and the second compartment 14. As such a fluid contents 42, 62 spilling from the burstable portion 40, 60 is communicated from the first compartment 12 to the second compartment 14, and mix and become activated.

FIG. 2, images 1 to 6, show how the sachet system of FIG. 1 or FIG. 3 is dispensed in a folded conformation and then used in operation to first to burst the sachets, then to mix the contents of the sachets, move the activated agent, for example, a biocide, adhesive, detergent, enzyme, bio-luminesent or similar such chemical made by combining previously separate solutiions of base and activator to the second empty compartment (or compartment with wet wipe material) and to manipulate and move the sachet system in order to fully wet the second compartment, and any material therein, with the activated solution.

In use, the steps 1-6 are followed. The construction is such that the seals on sachets 30, 50 are designed to be broken under the force and effort of manipulation by hand. This is illustrated in the drawings in FIG. 2.

FIG. 3 shows a sachet system similar in construction to that of FIG. 1. Compartment 12 includes a wipe or wetable material. In use the operations described in FIG. 2 are carried out in order to wet and cover the wetable material (or wipe) with the activated solution prepared by mixing the contents of the sachets 30, 50. In the event that there a sachet system 1000 with only one sachet then there may be a component of the activated solution outside the sachets 30 in regions S ready to combine with the contents of 30 when the seal has been breached.

The steps of the operation are as follows; multiple packs of the sachet system 1000 are stored in a box dispenser from which a user removes a pack. The portion of the pack containing the burstable portions is rolled and manipulated, and force is exerted on it until the seal 40 bursts. Then at operation 4 the portion N of the system with the wetable material or a void is twisted to ensure distribution of the quota of activated solution. Any wetable material is accessed, or the active solution waiting to be used, for dilution for example, by tearing at a weakened portion of the sachet system. This might be an easy tear region, a region of less sealed area, notch or perforations. Once separated the portion to be used is as follows—the wetable material is removed from the portion or 12. The wipe or wetable material 100 is used to wipe over a surface such as a medical device—all surfaces of the device should be wiped to ensure all areas have been reached with the activated solution.

Various modifications may be made to the described embodiments without departing from the scope of the present invention. The body and compartment portions or overall sachet system may be of an alternative shaping and may comprise any suitable material and may be of varying length and thickness. Alternative forms of construction may be considered. The flat faces of the sachets may comprise signage selected from the range of; colourways, company name, hazard warnings, information on use by date, CE regulations, standards and trade terms. There may also be printed on the sachets instructions for use, reminders etc. The number of burstable sachets and the variety and combination of their contents may vary. The number of sachets may vary within the master pouch. Two or more sachets can be added to the master sachet if two or more chemicals are required to be mixed and reacted with each other. In addition in some variations there may be material for use and activation outside the sachets but inside the master pouch. The seals may be made and secured by other methods of sealing other than heat, for example by pressure sealing or adhesive.

1. A sachet system enclosed in a pouch, the pouch comprising at least two strips of film material of approximately the same size, one overlaid on the other, sealed together at their edges and further sealed together at least once at a point along at least one axis with a partial seal to form at least two joined substantially planar regions, one of which regions comprises a first compartment, another of which regions comprises a second compartment, and wherein the first compartment is separated from the second compartment by the partial seal, the sachet system comprising a burstable portion containing a fluid and located in the first compartment, the partial seal providing a communication path between the first compartment and the second compartment, and wherein the system is capable of being manipulated such that the burstable portion bursts, and arranged such that a fluid contents spilling from the burstable portion is communicated from the first compartment to the second compartment.

2. A sachet system as claimed in claim 1, wherein the burstable portion comprises a sachet comprising at least two strips of film material of approximately the same size, one overlaid on the other, sealed together at their edges, wherein the seal at one edge is weaker than the seal at the other edges, whereby under manipulation the weaker seal is caused to fail so as to burst the sachet and spill the fluid contents of the sachet.

3. A sachet system as claimed in claim 1, wherein the first compartment comprises two or more burstable sachets.

4. A sachet system as claimed in claim 1, wherein the second compartment is wetted with an active formulation from the first compartment produced by combining the contents of the burstable sachets by simultaneous discharge of the active formulation into the second compartment.

5. A sachet system as claimed in claim 4, wherein the fluid contents comprises an active biocide produced by combining two or more separate liquids.

6. A sachet system as claimed in claim 3, wherein a first burstable sachet contains an activator and a second burstable sachet contains a base.

7. A sachet system as claimed in claim 6, wherein the activator is one chosen from the range; benzoyl peroxide, adeptic acid, alkaline hydrogen peroxide.

8. A sachet system as claimed in claim 6, wherein the base is one chosen from the range; polymethyl methacrylate resin, calcium hypochlorite, TEAD.

9. A sachet system as claimed in claim 3, wherein the first compartment comprises two or more burstable sachets and wherein one or more of the burstable sachets contains a predetermined volume of fluid.

10. (canceled)

11. A sachet system as claimed in claim 1, wherein the pouch film comprises a plastics material and is transparent.

12. A sachet system as claimed in claim 1, wherein the burstable portion comprises metal foil sachets.

13. A sachet system as claimed in claim 1, wherein the pouch film seals and sachet film seals are sealed by a heat sealing process.

14. A sachet system as claimed in claim 1, wherein the manipulation of the pouch is configured to be carried out manually.

15. A sachet system as claimed in claim 1, wherein the manipulation of the pouch is configured to be carried out in an automated manner.

16. A sachet system as claimed in claim 1, wherein one or more of the pouch and component portions are in a sterile, clean state.

17. A sachet system as claimed in claim 1, wherein the second compartment comprises a wetable material portion, and wherein the wetable portion is configured to be wetted by a said fluid contents.

18. A sachet system as claimed in claim 1, wherein the wetable portion is chosen from the group consisting of wetable fabric material, paper, tissue, gauze, and wet wipe material.

19. A sachet system as claimed in claim 1, further comprising a perforated or weakened area of the pouch arranged for ease of opening such that the contents of the sachet may be released, or the wetable material portion may be removed from the pouch for use.

20. A method of manufacture of a sachet system, pouch and at least one burstable portion as claimed claim 1, comprising (i) folding and sealing the burstable sachet, (ii) filling the burstable sachet with components capable of creating an active biocide when mixed and combined and (iii) folding and sealing the master pouch around the burstable sachet.

21. A method of manufacture of a sachet system, pouch and at least one burstable portion as claimed in claim 20, further comprising (iv) folding and sealing a wetable portion with material to be wetted and (v) folding and sealing the master pouch around the burstable sachets and the wetable portion.

22-23. (canceled)
